(19) United States
(12) Patent Application Publication
(10) Pub. No.: US 2022/0361421 A1
(43) Pub. Date: Nov. 17, 2022

(54) PLANT EDGING

(71) Applicant: Roland Jackson, Brampton (CA)

(72) Inventor: Roland Jackson, Brampton (CA)

(21) Appl. No.: 17/743,170

(22) Filed: May 12, 2022

Related U.S. Application Data
(60) Provisional application No. 63/189,006, filed on May 14, 2021.

(51) Int. Cl. A01G 9/28

(52) U.S. Cl. CPC A01G 9/28

(57) ABSTRACT

An edging system is disclosed herein. The edging system includes a set of annular members having a plurality of first engagement portions and a plurality of second engagement portions. In some embodiments, each annular member is modular. Adjacent annular members are configured to join together via engagement of the plurality of first engagement portions and the plurality of second engagement portions thereon. The edging system edging provides a barrier for the plant, protecting the plant whilst providing a tidy and aesthetically pleasing appearance to the plant and the yard/garden as a whole.

### CROSS-REFERENCE TO RELATED APPLICATION

The present application is related to and claims priority to U.S. Provisional Patent Application No. 63/189,006 filed May 14, 2021, which is incorporated by reference herein in its entirety.

### BACKGROUND OF THE INVENTION

The following includes information that may be useful in understanding the present disclosure. It is not an admission that any of the information provided herein is prior art nor material to the presently described or claimed inventions, nor that any publication or document that is specifically or implicitly referenced is prior art.

### TECHNICAL FIELD

The present invention relates generally to the field of plant accessories of existing art and more specifically relates to decorative and protective edging for plants, particularly trees.

### RELATED ART

Edging is an important feature in a well maintained yard or garden. Edging creates a border around a plant, particularly a tree, which provides a decorative appearance to the plant, protects and provides a barrier for the plant and maintains a tidy overall appearance to the yard/garden. An example type of edging currently used includes masonry edging composed of stone, brick and/or concrete. However, it is generally expensive to buy edging stone to form stone circles around the trees. Further, these circular structures made from stone, brick and/or concrete are difficult to position above each other, and therefore may not be aesthetically appealing. As such, a suitable solution is desired.

### SUMMARY OF THE INVENTION

In view of the foregoing disadvantages inherent in the known plant accessory art, the present disclosure provides a novel plant edging. The general purpose of the present disclosure, which will be described subsequently in greater detail, is to provide a modular edging system configured to be stacked vertically and surround/encircle a base of a plant, such as a tree.

An edging system for a plant is disclosed herein. The edging system includes a set of annular members, a plurality of first engagement portions and a plurality of second engagement portions. The set of annular members may be configured to be vertically stacked to form the edging system. Particularly, the set of annular members may include a base member, at least one central member and a cap member all having a top surface opposite a bottom surface. The plurality of first engagement portions may be located on respective top surfaces of the base member and the at least one central member and the plurality of second engagement portions may be located on respective bottom surfaces of the at least one central member and the cap member. As such, adjacent annular members may be configured to join together (stack) via engagement of the plurality of first engagement portions and the plurality of second engagement portions thereon.

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and methods of use for the present disclosure, plant edging, constructed and operative according to the teachings of the present disclosure.

FIG. 1 is a perspective view of an edging system being used to edge/border a plant such as a tree, according to an embodiment of the disclosure.

FIG. 2 is a partial exploded view of the edging system illustrating a set of annular members, according to an embodiment of the present disclosure.

FIG. 3 is a top perspective view of a base member, according to an embodiment of the present disclosure.

FIG. 4 is a bottom perspective view of a central member, according to an embodiment of the present disclosure.

FIG. 5 is a top perspective view of a cap member, according to an embodiment of the present disclosure.

FIG. 6 is a bottom perspective view of the cap member, according to an embodiment of the present disclosure.

FIG. 7 is an exploded view of the set of annular members, particularly illustrating the base member, two central members and the cap member each being made up of at least two arcuate sections, according to an embodiment of the present disclosure.

The various embodiments of the present invention will hereinafter be described in conjunction with the appended drawings, wherein like designations denote like elements.

### DETAILED DESCRIPTION

As discussed above, embodiments of the present disclosure relate to plant accessories and more particularly to plant edging used for edging a base of a plant, such as a tree. As such, the plant edging may provide a barrier for the tree, protecting the tree whilst providing a tidy and aesthetically pleasing appearance to the tree and the yard/garden as a whole.

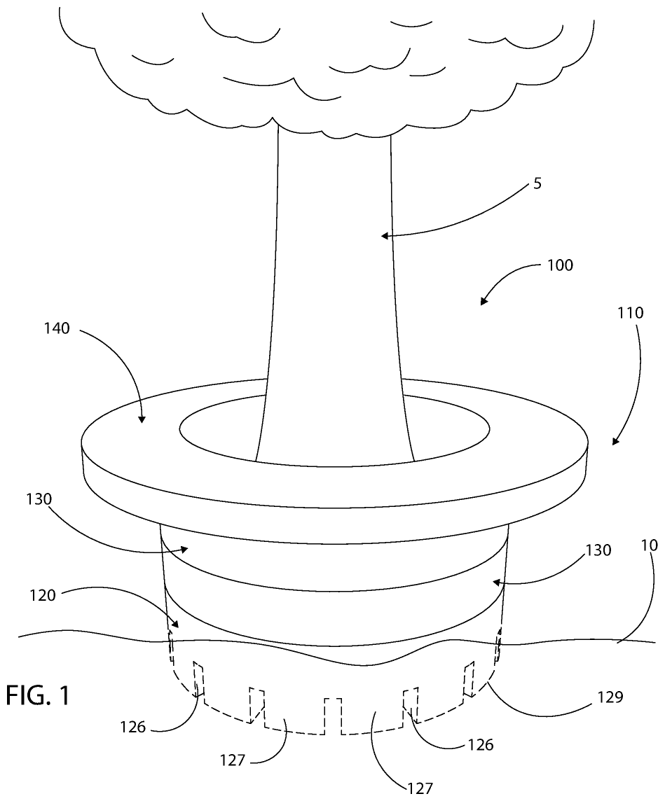

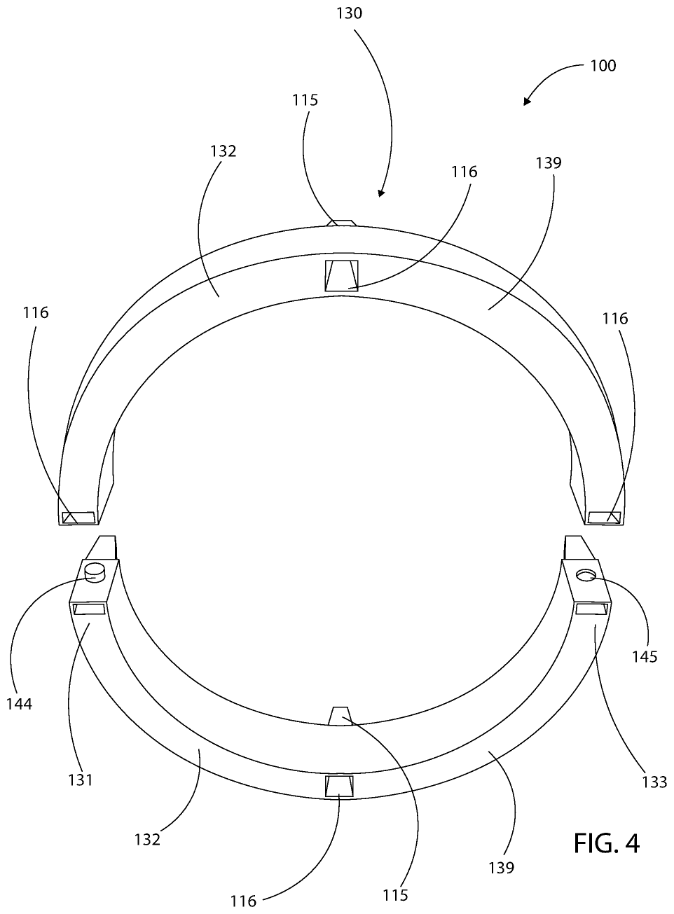

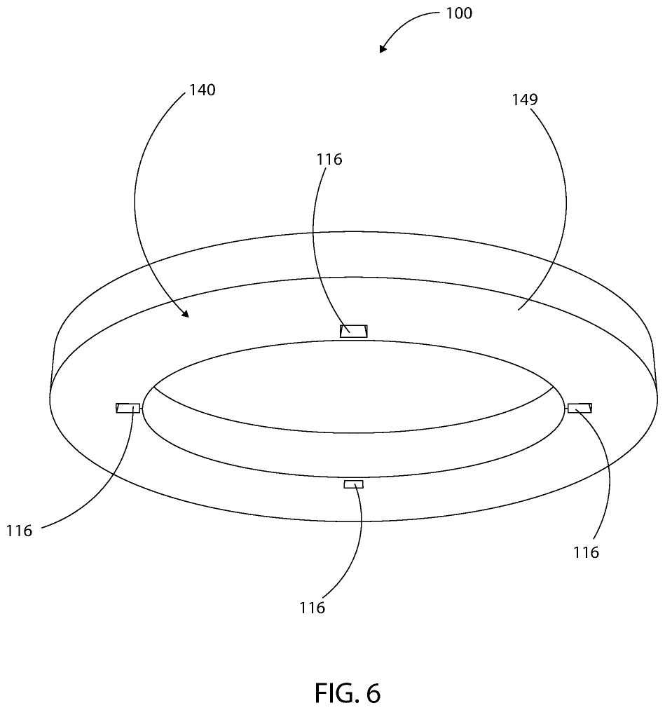

Referring now more specifically to the drawings by numerals of reference, there is shown in FIGS. 1-7, various views of an edging system 100 for a plant 5. As shown, the edging system 100 may include a set of annular members 110. As shown in FIG. 1, the edging system 100 may be used for edging/bordering a plant 5. Particularly, the edging system 100 may provide a decorative border/edge for a base of the plant 5. In some examples, as shown in FIG. 1 and as discussed above, the plant 5 may be a tree. It should however be appreciated that the edging system 100 is not limited to use with trees.

The set of annular members 110 may be configured to be vertically stacked to form the edging system 100, as shown in FIGS. 1-2 and FIG. 7. The set of annular members 110 may include a base member 120, at least one central member 130 and a cap member 140. In some embodiments, as shown in FIGS. 1-2 and FIG. 7, the annular members 110 may be stacked base member 120 first, the at least one central member 130 next and cap member 140 last (from bottom to top of the edging system 100).

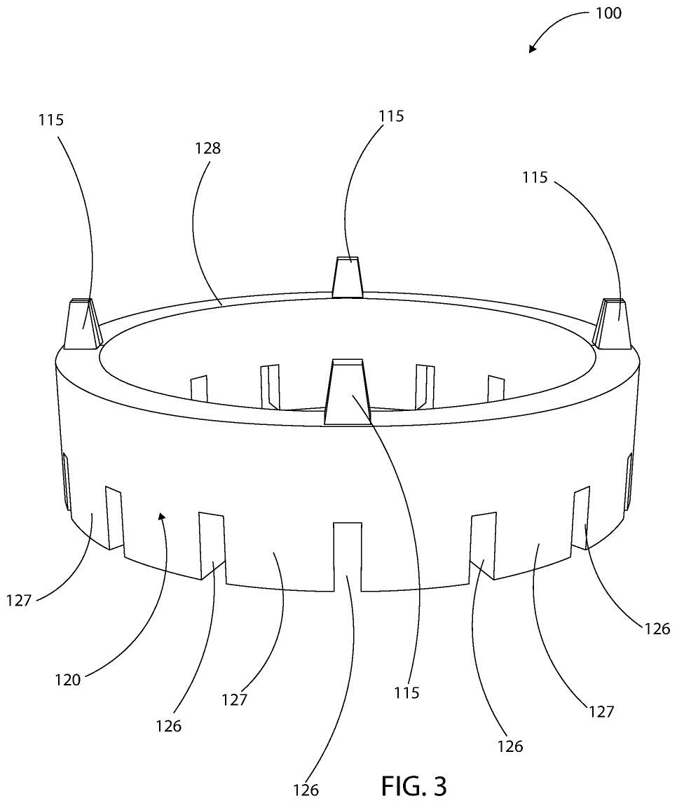

In some embodiments, the base member 120 may include a plurality of openings 126 located about the bottom surface 129 thereof. As shown particularly in FIG. 1 and FIG. 3, in some embodiments, the plurality of openings 126 may be defined by downwardly extending segments 127 spaced about a circumference of the base member 120 and extending substantially perpendicular to a top surface 128 of the base member 120. As shown in FIG. 1, when the edging system 100 surrounds/encircles the base of the plant 5, as discussed above, the bottom surface 129, the downwardly extending segments 127 and thus the plurality of openings 126 may be submerged underneath a ground surface 10. The downwardly extending segments 127 and the plurality of openings 126 are shown via broken lines in FIG. 1 for clarity to demonstrate them being submerged underneath the ground surface 10. As such, the plurality of openings 126 may aid in drainage and allow clearance for shallow roots of the plant 5.

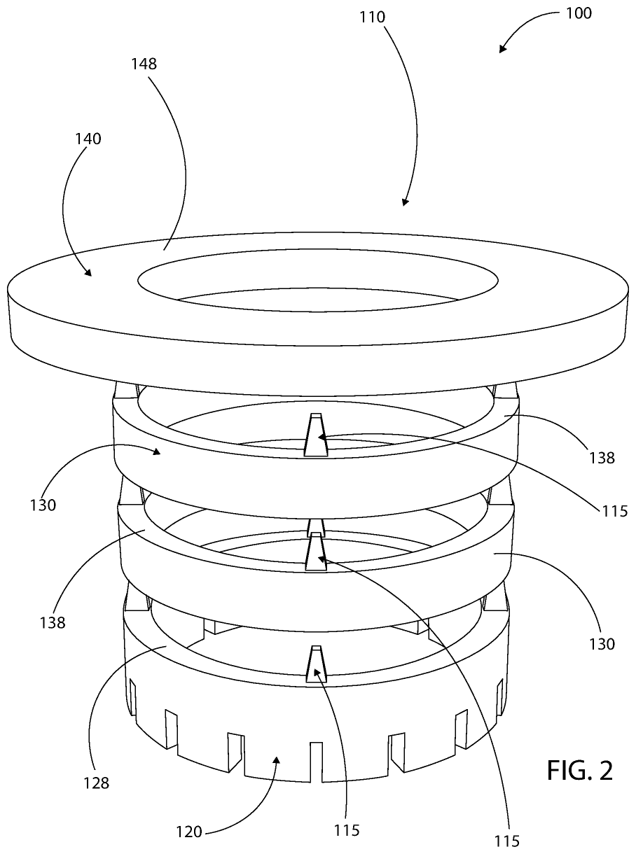

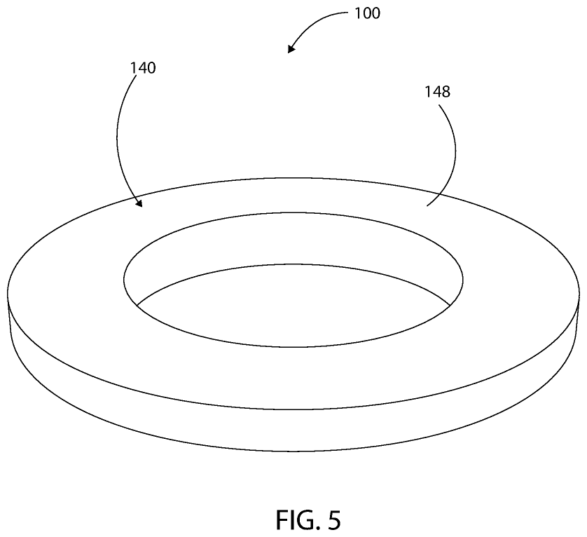

Further, as shown and as discussed above, the cap member 140 may be configured for placement at a top of the edging system 100. As shown particularly in FIG. 1 and FIG. 2, the cap member 140 may include a diameter larger than a diameter of the base member 120 and the at least one central member 130. Further, as shown in FIG. 5, a top surface 148 of the cap member 140 may not include any engagement portions and may be smooth. In some embodiments, the cap member 140 may define a flange of the edging system 100.

The set of annular members 110 may each include engagement portions to enable vertical stacking thereof. For example, as shown in FIGS. 2-7, the base member 120 and the at least one central member 130 may each include a plurality of first engagement portions 115 on respective top surfaces 128, 138 thereof; and the at least one central member 130 and the cap member 140 may each include a plurality of second engagement portions 116 on respective bottom surfaces 139, 149 thereof. As such, as shown in FIG. 1, two adjacent annular members 110 may be configured to join together (stack) via engagement of the plurality of first engagement portions 115 and the plurality of second engagement portions 116 thereon.

For example, the base member 120 may join with the at least one central member 130 or the cap member 140 via the plurality of first engagement portions 115 on the top surface 128 of the base member 120 and the plurality of second engagement portions 116 on the bottom surface 139, 149 of either the at least one central member 130 or the cap member 140. As shown in FIGS. 1-2 and FIG. 7, in some embodiments, the at least one central member 130 may include more than one central member 130. For example, as shown in FIGS. 1-2 and FIG. 7 the set of annular members 110 may include two central members 130 (it should however be appreciated that the central member 130 is not limited to two). As such, adjacent central members 130 may join together via the plurality of first engagement portions 115 on the top surface 138 of one central member 130 and the plurality of second engagement portions 116 on the bottom surface 139 of another central member 130. A top central member 130 may then join to the cap member 140 via the plurality of first engagement portions 115 on the top surface 138 of the top central member 130 and the plurality of second engagement portions 116 on the bottom surface 149 of the cap member 140.

As shown in FIGS. 2-7, in some embodiments, the plurality of first engagement portions 115 may include a plurality of protrusions 117 and the plurality of second engagement portions 116 may include a plurality of slots 118. As such, each protrusion 117 may be configured to insert into one of the plurality of slots 118. The plurality of protrusions 117 may extend substantially perpendicular to the top surface 128, 138, 148 of each annular member 110. In some embodiments, the plurality of protrusions 117 may include a substantially trapezoidal shape. As such, the plurality of slots 118 may each include a cavity that matches the substantially trapezoidal shape of the protrusions 117. However, it should be appreciated that the protrusions 117/slots 118 are not limited to this shape. For example, in some embodiments, the protrusion/slots 118 may include a circular shape, a spherical shape, a cuboid shape, a conical shape, etc.

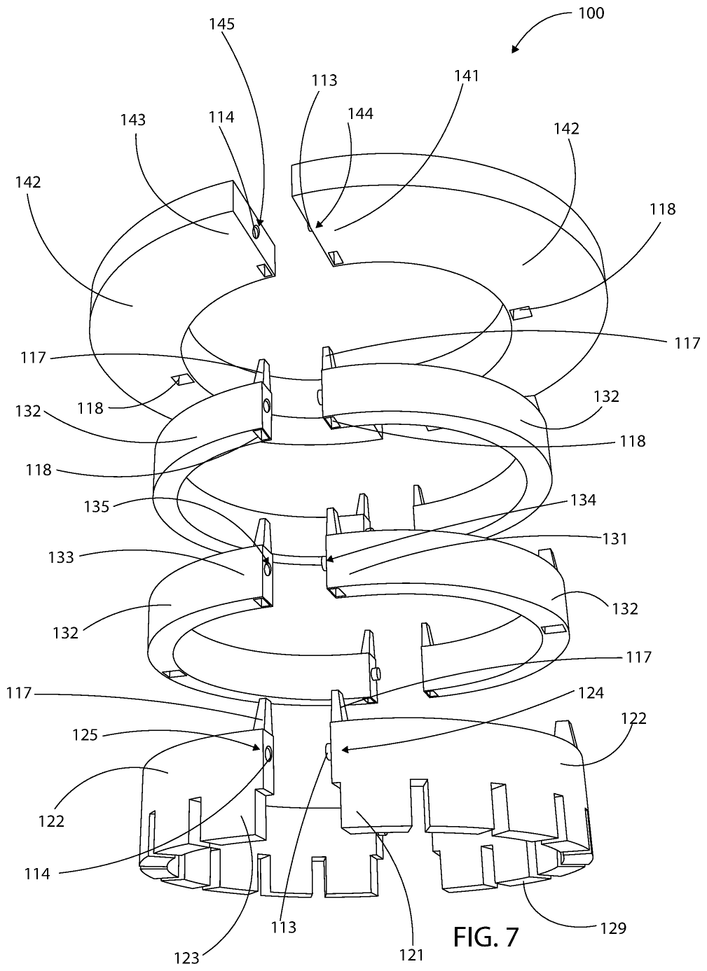

In some embodiments, as shown in particularly in FIG. 7, each of the annular members 110 may be modular. For example, the base member 120 may be defined by at least two arcuate base member sections 122; the at least one central member 130 may be defined by at least two arcuate central member sections 132; and the cap member 140 may be defined by at least two arcuate cap member sections 142. It should be appreciated that whilst two arcuate members per annular member 110 are shown in these figures, the annular members 110 are not limited to being made up of only two arcuate (or at least partially arcuate) members; nor are the annular members 110 limited to being modular or being made up of separate members.

As shown in FIG. 7 particularly, each of the arcuate base member sections 122 may include a first base member end 121 and a second base member end 123. The first base member end 121 may include a first base connector portion 124, the second base member end 123 may include a second base connector portion 125, and the first base connector portion 124 of each arcuate base member section 122 may be configured to connect with the second base connector portion 125 of each arcuate base member section 122 to form the base member 120.

Similarly, each of the arcuate central member sections 132 may include a first central member end 131 and a second central member end 133. The first central member end 131 may include a first central connector portion 134, the second central member end 133 may include a second central connector portion 135, and the first central connector portion 134 of each arcuate central member section 132 may be configured to connect with the second central connector portion 135 of each arcuate central member section 132 to form the at least one central member 130.

In addition, each of the arcuate cap member sections 142 may include a first cap member end 141 and a second cap member end 143. The first cap member end 141 may include a first cap connector portion 144, and the second cap member end 143 may include a second cap connector portion 145. The first cap connector portion 144 of each arcuate cap member section 142 may be configured to connect with the second cap connector portion 145 of each arcuate cap member section 142 to form the cap member 140.

Particularly, in some embodiments, the first base connector portion 124, the first central connector portion 134 and the first cap connector portion 144 may each include a protuberance 113; and the second base connector portion 125, the second central connector portion 135 and the second cap connector portion 145 may each include a groove 114 configured to receive the protuberance 113. In some examples, the protuberance 113 may include a circular nub extending parallel to the first member ends (121, 123, 131, 133, 141, 143). As such, each groove 114 may include a circular cavity configured to receive the protuberance 113. It should however be appreciated that the protuberance 113/groove 114 are not limited to the above described and shown shape. For example, similar to the protrusions 117/slots 118 above, the protuberance 113/groove 114 may include a spherical shape, a cuboid shape, a conical shape, a trapezoidal shape, etc.

In use, in some embodiments, a user may place one of the arcuate base member sections 122 one side of the base of the plant 5 and another one of the arcuate base member sections 122 on another side of the base of the plant 5 and then fasten the arcuate base member sections 122 together via the base connector portions 124, 125. In some embodiments, the user may install the base member 120 such that the plurality of openings 126 are placed under the ground surface 10. The user may then place one of the arcuate central member sections 132 one side of the base of the plant 5 and another one of the arcuate central member sections 132 on another side of the base of the plant 5, connect the arcuate central member sections 132 together via the central connector portions 134, 135 and join the at least one central member 130 to the base member 120 via the plurality of first engagement portions 115 on the top surface 128 of the base member 120 and the plurality of second engagement portions 116 on the bottom surface 139 of the at least one central member 130.

In some embodiments, the user may next attach additional central members 130 to the central member 130. The cap member 140 may then be attached to the top of the edging system 100. This may be achieved by placing one of the arcuate cap member sections 142 on one side of the base of the plant 5 and another one of the arcuate cap member sections 142 on another side of the base of the plant 5. The user may then connect the arcuate cap member sections 142 together via the cap connector portions 144, 145 and may connect the cap member 140 to the top central member 130 via the plurality of first engagement portions 115 on the top surface 138 of the top central member 130 and the plurality of second engagement portions 116 on the bottom surface 149 of the cap member 140.

It should be noted that certain steps are optional and may not be implemented in all cases. It should also be noted that the steps described above can be carried out in many different orders according to user preference. The use of “step of” should not be interpreted as “step for”, in the claims herein and is not intended to invoke the provisions of 35 U.S.C. § 112(f). It should also be noted that, under appropriate circumstances, considering such issues as design preference, user preferences, marketing preferences, cost, structural requirements, available materials, technological advances, etc., other methods for assembling and using an edging system for edging a plant are taught herein.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. An edging system for a plant, the system comprising:
a set of annular members configured to be vertically stacked to form the edging system, the set of annular members including a base member, at least one central member and a cap member all having a top surface opposite a bottom surface;
a plurality of first engagement portions located on respective top surfaces of the base member and the at least one central member; and
a plurality of second engagement portions located on respective bottom surfaces of the at least one central member and the cap member; and
wherein adjacent annular members are configured to join together via engagement of the plurality of first engagement portions and the plurality of second engagement portions thereon.

2. The edging system of claim 1, wherein the base member is defined by at least two arcuate base member sections.

3. The edging system of claim 2, wherein each of the arcuate base member sections include a first base member end and a second base member end, wherein the first base member end includes a first base connector portion, wherein the second base member end includes a second base connector portion, and wherein the first base connector portion of each arcuate base member section is configured to connect with the second base connector portion of each arcuate base member section to form the base member.

4. The edging system of claim 3, wherein the at least one central member is defined by at least two arcuate central member sections.

5. The edging system of claim 4, wherein each of the arcuate central member sections include a first central member end and a second central member end, wherein the first central member end includes a first central connector portion, wherein the second central member end includes a second central connector portion, and wherein the first central connector portion of each arcuate central member section is configured to connect with the second central connector portion of each arcuate central member section to form the at least one central member.

6. The edging system of claim 5, wherein the cap member is defined by at least two arcuate cap member sections.

7. The edging system of claim 6, wherein each of the arcuate cap member sections include a first cap member end and a second cap member end, wherein the first cap member end includes a first cap connector portion, wherein the second cap member end includes a second cap connector portion, and wherein the first cap connector portion of each arcuate cap member section is configured to connect with the second cap connector portion of each arcuate cap member section to form the cap member.

8. The edging system of claim 7, wherein the first base connector portion, the first central connector portion and the first cap connector portion each include a protuberance.

9. The edging system of claim 8, wherein the second base connector portion, the second central connector portion and the second cap connector portion each include a groove.

10. The edging system of claim 1, wherein the plurality of first engagement portions include a plurality of protrusions.

11. The edging system of claim 10, wherein the plurality of second engagement portions include a plurality of slots.

12. The edging system of claim 1, wherein the base member includes a plurality of openings located about the bottom surface thereof.

13. The edging system of claim 1, wherein the cap member includes a diameter larger than a diameter of the base member and the at least one central member.

14. An edging system for a plant, the system comprising:
a set of annular members configured to be vertically stacked to form the edging system, the set of annular members including a base member, at least one central member and a cap member all having a top surface opposite a bottom surface;
a plurality of first engagement portions located on respective top surfaces of the base member and the at least one central member;
a plurality of second engagement portions located on respective bottom surfaces of the at least one central member and the cap member;
wherein the base member includes a plurality of openings located about the bottom surface thereof, the base member being defined by at least two arcuate base member sections, each of the arcuate base member sections including a first base member end and a second base member end, the first base member end including a first base connector portion, the second base member end including a second base connector portion, the first base connector portion of each arcuate base member section being configured to connect with the second base connector portion of each arcuate base member section to form the base member;
wherein the at least one central member is defined by at least two arcuate central member sections, each of the arcuate central member sections including a first central member end and a second central member end, the first central member end including a first central connector portion, the second central member end including a second central connector portion, the first central connector portion of each arcuate central member section being configured to connect with the second central connector portion of each arcuate central member section to form the at least one central member;
wherein the cap member is defined by at least two arcuate cap member sections, each of the arcuate cap member sections including a first cap member end and a second cap member end, the first cap member end including a first cap connector portion, the second cap member end including a second cap connector portion, the first cap connector portion of each arcuate cap member section being configured to connect with the second cap connector portion of each arcuate cap member section to form the cap member; and
wherein adjacent annular members are configured to join together via engagement of the plurality of first engagement portions and the plurality of second engagement portions thereon.

15. The edging system of claim 14, wherein the plurality of first engagement portions include a plurality of protrusions.

16. The edging system of claim 15, wherein the plurality of second engagement portions include a plurality of slots.

17. The edging system of claim 14, wherein the first base connector portion, the first central connector portion and the first cap connector portion each include a protuberance.

18. The edging system of claim 17, wherein the second base connector portion, the second central connector portion and the second cap connector portion each include a groove.

19. The edging system of claim 14, wherein the cap member includes a diameter larger than a diameter of the base member and the at least one central member.

20. An edging system for a plant, the system comprising:
a set of annular members configured to be vertically stacked to form the edging system, the set of annular members including a base member, at least one central member and a cap member all having a top surface opposite a bottom surface;
a plurality of protrusions located on respective top surfaces of the base member and the at least one central member;
a plurality of slots located on respective bottom surfaces of the at least one central member and the cap member; and
wherein the base member includes a plurality of openings located about the bottom surface thereof, the base member being defined by at least two arcuate base member sections, each of the arcuate base member sections including a first base member end and a second base member end, the first base member end including a first base connector portion, the second base member end including a second base connector portion, the the first base connector portion of each arcuate base member section being configured to connect with the second base connector portion of each arcuate base member section to form the base member;
wherein the at least one central member is defined by at least two arcuate central member sections, each of the arcuate central member sections including a first central member end and a second central member end, the first central member end including a first central connector portion, the second central member end including a second central connector portion, the first central connector portion of each arcuate central member section being configured to connect with the second central connector portion of each arcuate central member section to form the at least one central member;
wherein the cap member includes a diameter larger than a diameter of the base member and the at least one central member, the cap member being defined by at least two arcuate cap member sections, each of the arcuate cap member sections including a first cap member end and a second cap member end, the first cap member end including a first cap connector portion, the second cap member end including a second cap connector portion, the first cap connector portion of each arcuate cap member section being configured to connect with the second cap connector portion of each arcuate cap member section to form the cap member; and
wherein the first base connector portion, the first central connector portion and the first cap connector portion each include a protuberance;
wherein the second base connector portion, the second central connector portion and the second cap connector portion each include a groove; and
wherein adjacent annular members are configured to join together via engagement of the plurality of protrusions and the plurality of slots thereon.
